(19) United States
(12) Patent Application Publication
(10) Pub. No.: US 2020/0311191 A1
(43) Pub. Date: Oct. 1, 2020

(54) ELECTRONIC DOCUMENT REVIEW COMMENT AGGREGATION SYSTEM, NON-TRANSITORY COMPUTER READABLE MEDIUM THEREOF, ELECTRONIC DOCUMENT REVIEW COMMENT AGGREGATION AND INPUT APPARATUS, AND NON-TRANSITORY COMPUTER READABLE MEDIUM THEREOF

(71) Applicant: FUJI XEROX CO., LTD., Tokyo (JP)

(72) Inventor: Hiroshi SEKINE, Kanagawa (JP)

(73) Assignee: FUJI XEROX CO., LTD., Tokyo (JP)

(21) Appl. No.: 16/551,739

(22) Filed: Aug. 27, 2019

(30) Foreign Application Priority Data
Mar. 25, 2019 (JP) 2019-056008

(51) Int. Cl. G06F 17/24; G06F 3/0484

(52) U.S. Cl. CPC G06F 17/241; G06F 3/0484

(57) ABSTRACT

An electronic document review comment aggregation system includes an aggregation request unit, an aggregation comment reception unit, an aggregation comment display unit, and an aggregation ending unit. The aggregation request unit requests, in a case where review comments are input for an overlapping position in an electronic document in an overlapping manner by plural reviewers, aggregation of the review comments for the overlapping position from the plural reviewers. The aggregation comment reception unit receives aggregation comments input for the aggregation by the plural reviewers. The aggregation comment display unit displays the received aggregation comments for the plural reviewers. The aggregation ending unit ends the aggregation in accordance with an aggregation ending condition.

### CROSS-REFERENCE TO RELATED APPLICATIONS

This application is based on and claims priority under 35 USC 119 from Japanese Patent Application No. 2019-056008 filed Mar. 25, 2019.

### BACKGROUND

### (i) Technical Field

The present disclosure relates to an electronic document review comment aggregation system, a non-transitory computer readable medium thereof, an electronic document review comment aggregation and input apparatus, and a non-transitory computer readable medium thereof.

### (ii) Related Art

A plurality of reviewers may review a document and provide review comments.

Japanese Unexamined Patent Application Publication No. 2018-5306 describes a mode in which review comments input to an electronic document are displayed in a display order and a display form based on characteristics of the review comments.

Japanese Unexamined Patent Application Publication No. 2010-3218 describes a technique for digitizing a handwritten document in which a review comment is provided into an electronic document and displaying the extracted review comment in association with the electronic document.

### SUMMARY

In the case where a plurality of review comments by different reviewers are provided for an overlapping position in a document, the plurality of review comments need to be aggregated in the process of finalizing the document. However, in Japanese Unexamined Patent Application Publication Nos. 2018-5306 and 2010-3218, a process of aggregation is not described, and a document creator seems to spend time and effort to perform adjustment with reviewers. Alternatively, in the case where the document creator chooses review comments without performing adjustment with the reviewers, opinions of the reviewers may not be properly reflected.

Aspects of non-limiting embodiments of the present disclosure relate to implementing aggregation of review comments by a plurality of reviewers in a case where the review comments are input by the plurality of reviewers for an overlapping position in an electronic document.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an electronic document review comment aggregation system including an aggregation request unit, an aggregation comment reception unit, an aggregation comment display unit, and an aggregation ending unit. The aggregation request unit requests, in a case where review comments are input for an overlapping position in an electronic document in an overlapping manner by a plurality of reviewers, aggregation of the review comments for the overlapping position from the plurality of reviewers. The aggregation comment reception unit receives aggregation comments input for the aggregation by the plurality of reviewers. The aggregation comment display unit displays the received aggregation comments for the plurality of reviewers. The aggregation ending unit ends the aggregation in accordance with an aggregation ending condition.

### BRIEF DESCRIPTION OF THE DRAWINGS

Exemplary embodiments of the present disclosure will be described in detail based on the following figures, wherein:

FIG. 1 is a diagram illustrating a schematic configuration of a system according to an exemplary embodiment;

FIG. 2 is a diagram illustrating a schematic functional configuration of a document review processing server;

FIG. 3 is a diagram illustrating a schematic functional configuration of a review comment input apparatus;

FIG. 4 is a flowchart illustrating a review process of the document review processing server;

FIG. 5 is a flowchart illustrating a review process of the review comment input apparatus;

FIG. 6 is a flowchart illustrating an aggregation request process of the document review processing server;

FIG. 7 is a flowchart illustrating an aggregation process of the review comment input apparatus;

FIG. 8 is a flowchart illustrating an aggregation process of the document review processing server;

FIG. 9 is a diagram illustrating an example of an electronic document provided with review comments;

FIG. 10 is a diagram illustrating an aggregation process for the electronic document illustrated in FIG. 9; and

FIG. 11 illustrates a table for confirming that review comments are provided for an overlapping position.

### DETAILED DESCRIPTION

Hereinafter, a document system 10 according to an exemplary embodiment will be explained. The document system 10 is an example of an electronic document review comment aggregation system according to an exemplary embodiment. In this example, explanation will be provided on the assumption that the document system 10 is used by a plurality of users belonging to a company or the like during a process for collaboratively creating an electronic document. However, note that, for example, the document system 10 may also be widely used for private activities and the like.

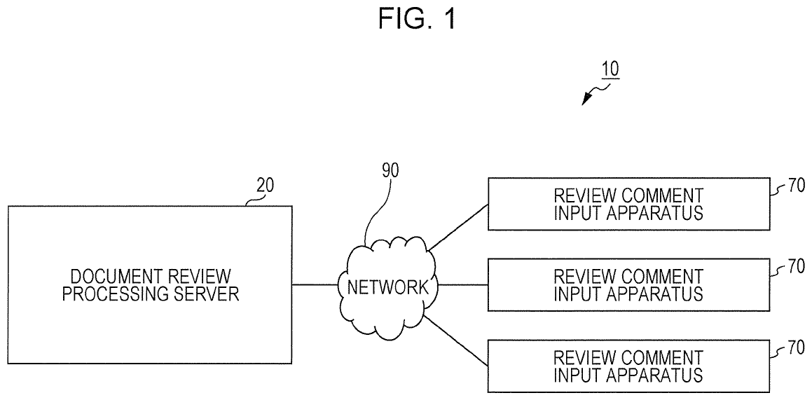

FIG. 1 is a diagram illustrating a schematic configuration of the document system 10 according to an exemplary embodiment. The document system 10 is a system that performs, as a whole, a process from reviewing an electronic document to aggregating review comments. In the document system 10, a document review processing server 20 and a plurality of review comment input apparatuses 70 are connected via a network 90 such as the Internet or intranet. The document review processing server 20 is an apparatus that functions as a server in the electronic document review comment aggregation system. Furthermore, the review comment input apparatuses 70 are apparatuses that function as clients in the electronic document review comment aggregation system. The review comment input apparatuses 70 are an example of electronic document review comment aggregation and input apparatuses according to an exemplary embodiment.

Terms will be explained below. Reviewing a document represents browsing the document and giving opinions, pointing out necessity of correction, making corrections, and the like for part of or the whole document. Users who provide reviews are called reviewers. Regarding reviewing of an electronic document, which is a digitized document, reviewers input opinions, input corrections, and perform other processes for the entire electronic document or a specified part of the electronic document. Such input of opinions, input of corrections, and other processes will be comprehensively referred to as review comments. Furthermore, aggregating review comments represents simplifying a plurality of review comments. Examples of aggregation include summarizing issues for various opinions, unifying opinions, and the like.

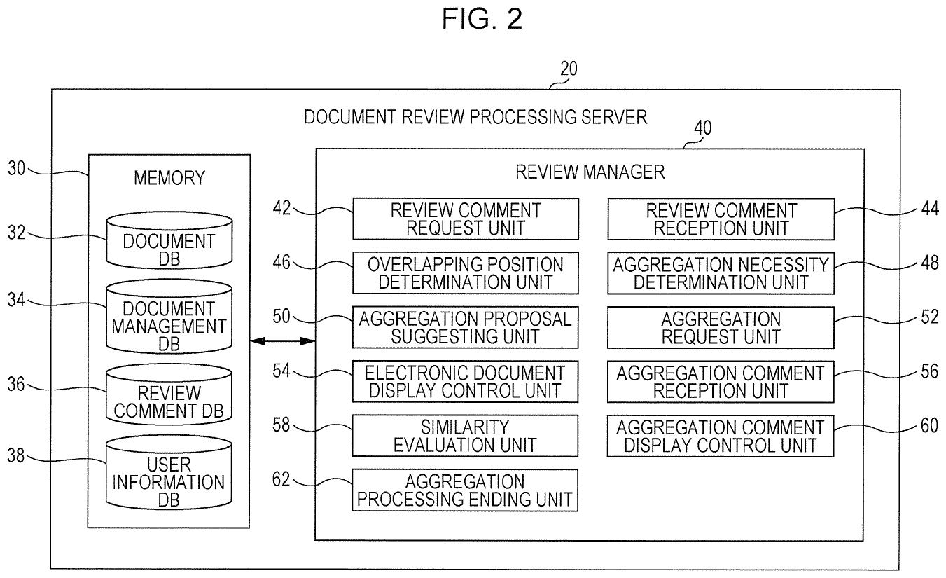

Next, the document review processing server 20 will be explained with reference to FIG. 2. For example, the document review processing server 20 may be implemented by a general-purpose personal computer (PC). The PC includes computer hardware including an arithmetic device such as a central processing unit (CPU), a memory device such as a semiconductor memory, a communication device that includes a communication circuit built therein and performs communication in a wired or wireless manner, a display device such as a display, and an input device such as a keyboard and a mouse. Programs (may be referred to as software) such as an operating system (OS) that performs basic processing and an application program (application) that performs specific applied processing are installed in the PC. The programs control the computer hardware, so that various processes are performed. However, the document review processing server 20 may be implemented by, for example, a plurality of apparatuses that are connected such that they are able to communicate with one another, in place of a single PC.

FIG. 2 is a block diagram illustrating a schematic functional configuration of the document review processing server 20. The document review processing server 20 includes a memory 30 and a review manager 40. The functions described below are implemented under the control of an application.

Various databases (DBs) including a document DB 32, a document management DB 34, a review comment DB 36, and a user information DB 38 are stored in the memory 30. The document DB 32 stores entity data of an electronic document as a review target. Typically, a document formed by letters and the like (letters, numbers, signs, etc.) electronically input by document creation software is used as an electronic document. However, a table, a diagram, or a photograph that is laid out along with letters and the like or without letters and the like is also regarded as an electronic document. Normally, letters, tables, and the like are digitized into an electronic document such that they are able to be edited. However, a document that is difficult to edit because the document is obtained by reading a paper document with a scanner or because editing restrictions are imposed on the document is also called an electronic document.

Document attributes, access right information, and the like of an electronic document stored in the document DB 32 are stored and managed by the document management DB 34. Document attributes represent information required for creation and edition of an electronic document, such as extension information of the electronic document, editing software information, or the like. Furthermore, access right information represents information for identifying a user or the like who is able to browse, edit, and other processes of an electronic document.

A review comment input for each electronic document is stored in the review comment DB 36. Accessory information such as a position in an electronic document for which a review comment is provided, the name of a user who has input the review comment, and the date and time input was performed is also stored in the review comment DB 36.

For each electronic document, information of a user who requests review and information of a reviewer who is a user who provides a review are stored and managed in the user information DB 38. Such user information includes, for example, information, such as a username, for identifying a user and user contact information such as an e-mail address.

The review manager 40 includes a review comment request unit 42, a review comment reception unit 44, an overlapping position determination unit 46, an aggregation necessity determination unit 48, an aggregation proposal suggesting unit 50, an aggregation request unit 52, an electronic document display control unit 54, an aggregation comment reception unit 56, a similarity evaluation unit 58, an aggregation comment display control unit 60, and an aggregation processing ending unit 62.

The review comment request unit 42 is an example of a review comment request unit. The review comment request unit 42 requests review of an electronic document from a reviewer. Specifically, based on input from a user as a review requester, an electronic document as a review target is selected, a reviewer is selected, a review period is set, and other processes are performed. After that, a request for review is transmitted to the reviewer. Transmission of a request may be performed, for example, by an e-mail or using a communication function between applications. Furthermore, an electronic document may be attached and transmitted or information on a link to the document DB 32 may be transmitted. In selection of an electronic document, selection of a reviewer, and storing and management of a selection result, the document DB 32, the document management DB 34, and the user information DB 38 are referred to.

The review comment reception unit 44 is an example of a review comment reception unit. The review comment reception unit 44 receives review comments from reviewers. In this exemplary embodiment, it is assumed that reviewers operate the review comment input apparatuses 70 to input review comments. The review comment reception unit 44 acquires and receives review comments by receiving information input to the review comment input apparatuses 70. The received review comments are stored in the review comment DB 36.

The overlapping position determination unit 46 determines whether or not a plurality of reviewers have provided review comments for an overlapping position in an electronic document (including a case where comment target positions are completely the same and a case where comment target positions partially overlap). In the case where a reviewer provides a review comment for the whole electronic document as a target, the review comment overlaps with all the other comments. Therefore, such a case is not regarded as a target for the determination. However, since there is a need to confirm the consistency between a review comment for the whole electronic document as a target and a review comment for part of the electronic document as a target, the review comment for the whole electronic document as a target may be regarded as a target for the determination regarding an overlapping position. Furthermore, a single reviewer may provide different review comments for an overlapping position in an electronic document. Normally, this case is not regarded as a target for determination regarding overlapping because there is a consistency among the plurality of review comments by the single reviewer. However, to simplify an editing processing operation by a review requester, in the case where a single reviewer provides review comments for an overlapping position, determination regarding overlapping may be performed.

The aggregation necessity determination unit 48 is an example of a determination unit. In the case where the overlapping position determination unit 46 determines that review comments are provided for an overlapping position, the aggregation necessity determination unit 48 determines whether or not there is a need to aggregate the review comments. For example, the aggregation necessity determination unit 48 determines, by performing semantic analysis of review comments using a learning algorithm or the like, whether or not there is a need to perform aggregation. For example, in the case where it is determined that the same contents are pointed out by a plurality of review comments, it is determined that there is no need to perform aggregation. Furthermore, in the case where review comments are consistent with each other, for example, one of the review comments represents pointing out or correction of an error in writing and the other one of the review comments represents an opinion on the contents, it is determined that there is no need to perform aggregation. In contrast, for example, in the case where conflicting opinions are provided in review comments, it is determined that there is a need to perform aggregation. Specifically, for example, in a state in which both review comments point out that there is a need to perform correction but policies for correction are different or in a state in which an item pointed out by a reviewer is in conflict with other review comments due to misunderstanding by the reviewer, it is determined that there is a need to perform aggregation. For example, in the case where learning is insufficient, the aggregation necessity determination unit 48 may not be able to precisely determine whether or not there is a need to perform aggregation. Therefore, the aggregation necessity determination unit 48 may not be used.

The aggregation proposal suggesting unit 50 is an example of a suggesting unit. In the case where the overlapping position determination unit 46 determines that review comments are provided for an overlapping position or the aggregation necessity determination unit 48 determines that there is a need to perform aggregation, the aggregation proposal suggesting unit 50 suggests an aggregation proposal for the review comments. A suggestion mode is possible in which semantic analysis is performed and a majority opinion is adopted in the case where there is an inconsistency among a plurality of review comments. Furthermore, as another example, a mode in which a review comment with a high priority (for example, a mode in which the order of priority of reviewers is defined as the order of priority of review comments, a mode in which priority increases as the review time becomes later, etc.) is used as an aggregation proposal is also possible. In suggestion, for example, a reasonable aggregation proposal may be presented based on past aggregation results, using a learning algorithm. However, for example, in the case where learning is insufficient, the aggregation proposal suggesting unit 50 may not be able to precisely suggest an aggregation proposal. Therefore, the aggregation proposal suggesting unit 50 may not be used.

The aggregation request unit 52 is an example of an aggregation request unit. In the case where the overlapping position determination unit 46 determines that review comments are provided for an overlapping position or the aggregation necessity determination unit 48 determines that there is a need to perform aggregation, the aggregation request unit 52 requests a review comment from a reviewer. For example, transmission of a request may be performed by an e-mail or using a communication function between applications. Furthermore, an electronic document may be attached and transmitted or information on a link to the document DB 32 may be transmitted.

For example, a mode is possible in which only reviewers who have provided reviews for an overlapping position are requested for aggregation and other reviewers are not involved in the aggregation. Furthermore, for example, reviewers who have provided reviews for an overlapping position may be requested for active aggregation, whereas the other reviewers may be informed that aggregation will be performed and assigned right to join the aggregation. Alternatively, all the reviewers who have reviewed an electronic document may be requested for aggregation. For example, the aggregation request unit 52 may request aggregation in accordance with an instruction from a user as a review requester or may automatically request aggregation after reception of review comments is finished. In requesting for aggregation, after an electronic document is specified, selection of a reviewer who is to be requested for aggregation, setting of an aggregation period, and the like are performed. Then, a request for aggregation is transmitted to the reviewer. In this process, the document DB 32, the document management DB 34, the review comment DB 36, and the user information DB 38 are referred to.

The electronic document display control unit 54 is an example of a partial functional configuration of an electronic document display unit. The electronic document display control unit 54 performs control for displaying an electronic document in the review comment input apparatuses 70 used by reviewers who perform aggregation. Specifically, the electronic document display control unit 54 performs processing for displaying an electronic document and clearly specifying a position in the electronic document for which a review comment is provided. In displaying positions for which review comments are provided, for example, control is performed such that a non-overlapping position, an overlapping position for which aggregation has not been performed, and an overlapping position for which aggregation has been performed may be recognized visually.

The aggregation comment reception unit 56 is an example of an aggregation comment reception unit. The aggregation comment reception unit 56 receives input for aggregation (referred to as aggregation comments) input by reviewers using the review comment input apparatuses 70. As an aggregation comment, letters may be input. Alternatively, an aggregation comment may be input using a button corresponding to an option (for example, a button for selecting an option for entrusting a reviewer with aggregation). Typically, an aggregation comment is input for each position where review comments overlap. However, for example, aggregation comments may be collectively input for a plurality of overlapping positions or all the overlapping positions.

The similarity evaluation unit 58 evaluates the similarity of aggregation comments. Similarity evaluation is performed by conducting semantic analysis or the like and evaluating that semantically similar comments have high similarity. For example, positive aggregation comments have high similarity, and negative comments have high similarity. In contrast, a positive aggregation comment and a negative aggregation comment are evaluated as having low similarity. Furthermore, among a plurality of review comments, aggregation comments referring to the same review comment are evaluated as having high similarly, whereas aggregation comments referring to different review comments are evaluated as having low similarity. The similarity evaluation unit 58 may be implemented by, for example, a learning algorithm. However, for example, due to insufficient learning, accuracy of similarity evaluation may be reduced. Therefore, the similarity evaluation unit 58 may not be used.

The aggregation comment display control unit 60 is an example of a partial functional configuration of an aggregation comment display unit. The aggregation comment display control unit 60 performs control for displaying an aggregation comment in association with an electronic document in the review comment input apparatuses 70 used by reviews who perform aggregation. For example, an aggregation comment is displayed in the same display such that the aggregation comment is able to be browsed along with a position in an electronic document for which a review comment is provided. Furthermore, for example, in the case where there are a plurality of positions for which review comments are provided, processing for displaying an aggregation comment for a position selected using a pointer or the like is performed. Display of aggregation comments may be performed in the order of similarity evaluated by the similarity evaluation unit 58. Alternatively, the aggregation comments may be displayed according to reviewers or in the chronological order of inputting.

The aggregation processing ending unit 62 is an example of an aggregation ending unit. The aggregation processing ending unit 62 performs processing for completing aggregation in accordance with an aggregation ending condition. The aggregation ending condition represents a condition to be satisfied to cause the aggregation processing ending unit 62 to complete aggregation. Specifically, the aggregation ending condition may be that an instruction for ending aggregation is received from one or more reviewers. For example, a mode is possible in which the aggregation ending condition is that all the reviewers who have reviewed an electronic document issue an ending instruction or all the reviewers who have input review comments for an overlapping position issue an ending instruction. Alternatively, the aggregation ending condition may be that a reviewer issues an ending instruction. From another point of view, a mode is possible in which it is determined that the aggregation ending condition is satisfied when a predetermined aggregation time has passed. After the aggregation processing ends, a requester for aggregation performs correction and the like of an electronic document in accordance with the aggregation comment.

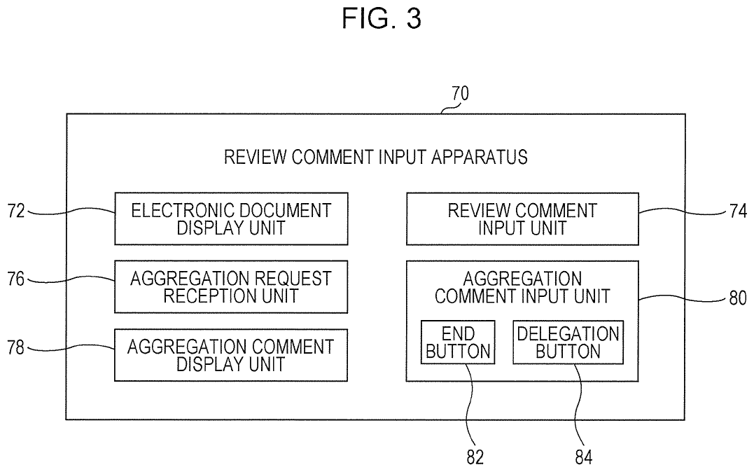

Next, the review comment input apparatuses 70 will be explained with reference to FIG. 3. The review comment input apparatuses 70 are each implemented by, for example, an apparatus such as a PC or a tablet. The review comment input apparatuses 70 may be implemented by a plurality of apparatuses connected such that they are able to communicate with one another. As with the document review processing server 20, the review comment input apparatuses 70 may be implemented by computer hardware and software including applications.

FIG. 3 is a block diagram illustrating a schematic functional configuration of each of the review comment input apparatuses 70. The review comment input apparatus 70 includes an electronic document display unit 72, a review comment input unit 74, an aggregation request reception unit 76, an aggregation comment display unit 78, and an aggregation comment input unit 80. These functions are implemented by applications.

The electronic document display unit 72 is an example of a partial functional configuration of the electronic document display unit. The electronic document display unit 72 displays an electronic document as a review target or an aggregation target and a review comment associated with the electronic document on the display. The electronic document display unit 72 is under the control of the electronic document display control unit 54 of the document review processing server 20, and displays a review comment provided for the electronic document by each reviewer.

The review comment input unit 74 is an example of a review comment input unit. At the stage of reviewing an electronic document, the review comment input unit 74 inputs a review comment in accordance with input by a reviewer as a user.

The aggregation request reception unit 76 is an example of an aggregation request reception unit. In the case where there is an aggregation request from the aggregation request unit 52 of the document review processing server 20, the aggregation request reception unit 76 receives the request instruction and notifies the reviewer as a user of the request instruction. In general, a user logs in the review comment input apparatus 70 by inputting a username to the review comment input apparatus 70 and receiving user authentication using a password or the like. Therefore, the aggregation request reception unit 76 recognizes that the aggregation request is issued to the user.

The aggregation comment display unit 78 is an example of a partial functional configuration of the aggregation comment display unit. The aggregation comment display unit 78 displays aggregation comments input from a plurality of reviewers who have been requested for aggregation. Under the control of the aggregation comment display control unit 60 of the document review processing server 20, the aggregation comment display unit 78 displays an aggregation comment in association with a position in an electronic document for which review comments are provided in an overlapping manner.

The aggregation comment input unit 80 is an example of an aggregation comment input unit. Based on an operation by a reviewer for inputting letters and the like, the aggregation comment input unit 80 inputs an aggregation comment. The aggregation comment input unit 80 includes an end button 82 and a delegation button 84 displayed on the display. The end button 82 is an example of an ending instruction image. The end button 82 is a button for receiving an instruction for ending aggregation processing from a reviewer. The delegation button 84 is an example of a delegation image. The delegation button 84 is a button for receiving from a reviewer an instruction to delegate aggregation processing to another reviewer. When a reviewer operates a pointer using a mouse or the like to click the end button 82 or the delegation button 84, input is performed.

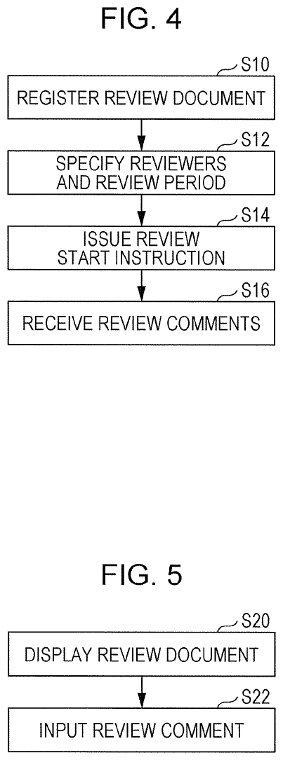

The flow from review of an electronic document to aggregation of review comments using the document system 10 will be explained below with reference to FIGS. 4 to 8.

FIG. 4 is a flowchart illustrating the flow of a process of the document review processing server 20 in the stage of reviewing an electronic document. First, a user who is a principal creator of an electronic document operates the document review processing server 20 to register the electronic document as a review target (S10). Accordingly, the electronic document is stored in the document DB 32, and document management information is set in the document management DB 34. Next, the user refers to the user information DB 38 to specify reviewers and sets a review period (S12). Then, when the user inputs an instruction to start reviewing, the review comment request unit 42 transmits a request to each of the reviewers (S14). After that, the document review processing server 20 receives review comments from the reviewers (S16). The received review comments may be or may not be referred to by other reviewers during the review period.

FIG. 5 is a flowchart illustrating the flow of a process of each of the review comment input apparatuses 70 in the stage of reviewing an electronic document. When a user as a reviewer is requested for review, the user causes the display of the review comment input apparatus 70 to display the electronic document (S20). Then, the user inputs a review comment via the review comment input unit 74. The review comment is input for the entire electronic document or a specified part of the electronic document (S22). The input review comment is transmitted to the review comment input apparatus 70 in real time or after the reviewer issues a transmission instruction, and the review comment input apparatus 70 receives the review comment. In principle, input of review comments is permitted only during the review period.

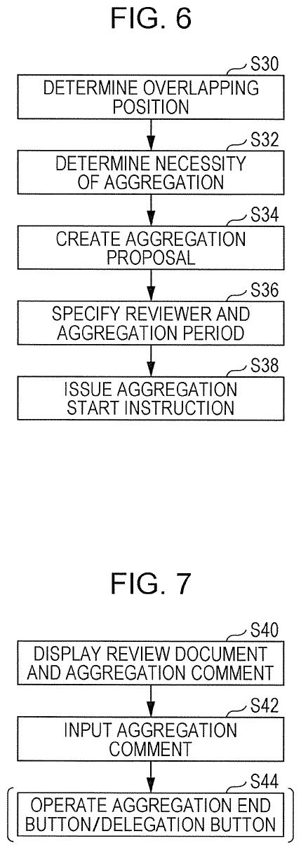

FIG. 6 is a flowchart illustrating the flow of a process of the document review processing server 20 in the stage of requesting aggregation of review comments of an electronic document. In the document review processing server 20, the overlapping position determination unit 46 determines whether or not review comments are provided for an overlapping position every time that a review comment is input or at appropriate intervals (for example, every day, every twelve hours, every six hours, etc.). In the case where review comments are provided for an overlapping position, for example, the overlapping position and the review comments provided for the overlapping position are displayed in an explicit manner even during the review period, so that adjustment of review comments during the review period may be prompted. Furthermore, at the point in time when the review period ends, the overlapping position determination unit 46 determines whether or not review comments are provided for an overlapping position (S30). In the case where review comments are provided for an overlapping position, the aggregation necessity determination unit 48 determines whether or not there is a need to perform aggregation (S32), and the aggregation proposal suggesting unit 50 creates an aggregation proposal (S34). However, the processing of S32 or S34 may be omitted. Then, an aggregation period is set (S36), and the aggregation request unit 52 transmits an instruction to start aggregation to a reviewer (S38). For example, the series of processing operations may be automatically performed based on preset settings or may be performed when a user as a requester inputs an execution instruction at this stage.

FIG. 7 is a flowchart illustrating the flow of a process of each of the review comment input apparatuses 70 in the stage of inputting an aggregation comment for an electronic document. In the review comment input apparatus 70, in the case where a request for aggregating review comments is issued, the electronic document display unit 72 displays an electronic document as a review target and review comments for the electronic document, and the aggregation comment display unit 78 displays an aggregation comment input by a reviewer by this stage (S40). The reviewer inputs an aggregation comment while referring to the electronic document, the review comments, and previous aggregation comments (S42). Aggregation comments may be input a desired number of times until aggregation finishes. Furthermore, the reviewer presses the end button 82 for aggregation or the delegation button 84, as needed (S44).

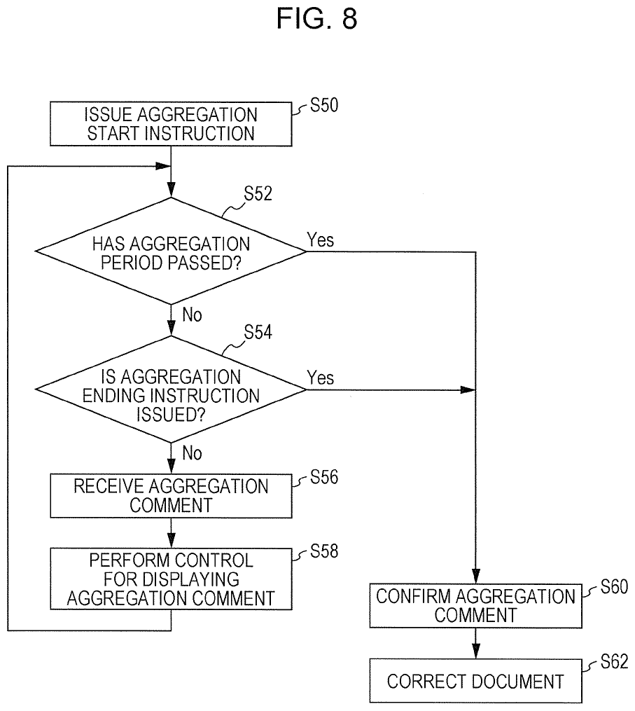

FIG. 8 is a flowchart illustrating the flow of a process of the document review processing server 20 after aggregation starts. When aggregation starts (S50), in the document review processing server 20, the aggregation processing ending unit 62 periodically checks whether or not the aggregation period has passed (S52). In the case where the aggregation period has not passed, the aggregation processing ending unit 62 checks, via the end button 82 for aggregation, whether or not an instruction to end aggregation is received from a reviewer (S54). In the example illustrated in FIG. 8, if an instruction to end aggregation is issued from a reviewer, aggregation ends.

During the period up to ending of aggregation, the aggregation comment reception unit 56 receives an aggregation comment input from each reviewer, as required (S56). The received aggregation comments are reflected, under the control of the aggregation comment display control unit 60, in display of aggregation comments in the review comment input apparatuses 70 used by the reviewers (S58).

In the case where the aggregation period has passed or an instruction to end aggregation is issued, the aggregation processing ending unit 62 ends the aggregation processing. Then, the user who has requested aggregation confirms the aggregation comments (S60), and corrects the electronic document (S62).

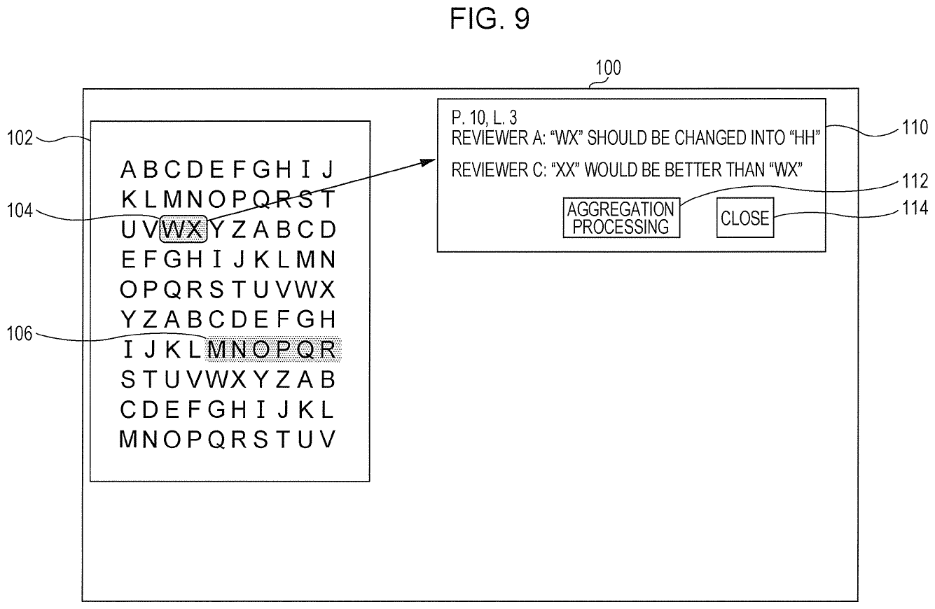

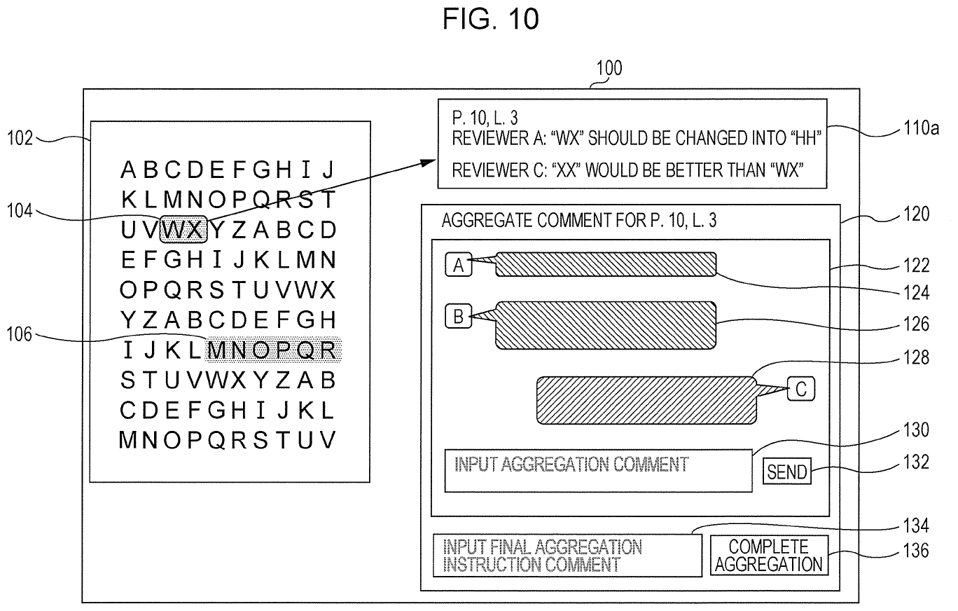

Next, a specific example of aggregation of review comments for an electronic document will be described with reference to FIGS. 9 and 10. FIGS. 9 and 10 are diagrams illustrating display on a screen 100 of the display of the review comment input apparatus 70 in a chronological manner.

In FIG. 9, an electronic document 102 is displayed on the screen 100. The electronic document 102 is formed by document creation software. A portion corresponding to “WX” in Line 3 is a highlighted portion 104 colored yellow, for example. For the highlighted portion 104, a plurality of review comments are provided and aggregation is not finished yet. Therefore, the highlighted portion 104 is displayed in a visually conspicuous manner.

In FIG. 9, it is assumed that a reviewer operates a mouse to click the highlighted portion 104. As a result, a window 110 is displayed while the relationship of the highlighted portion 104 and the window 110 being displayed by an arrow 108 on the screen 100. In the window 110, a plurality of review comments provided for the highlighted portion 104 are displayed. Specifically, the window 110 indicates that a review comment “‘WX’” should be changed into ‘HH’” by reviewer A and a review comment “‘XX’ would be better than ‘WX’” by reviewer B are input for Page 10, Line 3. Furthermore, in the window 110, an aggregation processing button 112 and a close button 114 are displayed. The aggregation processing button 112 is a button for opening a window for adjusting the two review comments. The close button 114 is a button for closing the window 110.

A portion corresponding to “MNOPQR” in Line 7 of the electronic document 102 is a shaded portion 106 filled in gray or the like. Only one review comment is provided for the shaded portion 106, and aggregation is thus unnecessary. Therefore, the shaded portion 106 is displayed in a relatively inconspicuous manner.

FIG. 10 illustrates the screen 100 in a state after a reviewer clicks the aggregation processing button 112 in FIG. 9. On the screen 100 illustrated in FIG. 10, the electronic document 102 continues to be displayed, as with the screen 100 in FIG. 9. The window 110 displayed on the screen illustrated in FIG. 9 is changed into a window 110a with a slightly reduced size in which the aggregation processing button 112 and the close button 114, which are displayed in a lower portion of the window 110, are not displayed. However, in the window 110a, the review comments provided in the window 110 continue to be displayed.

A new window 120 is displayed below the window 110a. The window 120 is provided for performing “comment aggregation for Page 10, Line 3”. A chat frame 122 for displaying and inputting aggregation comments through chat is displayed in the window 120. An aggregation comment 124 by reviewer A, an aggregation comment 126 by reviewer B, and an aggregation comment 128 by reviewer C are displayed in chronological order such that a newer comment is displayed in a lower side. An input field 130 for inputting a new aggregation comment and a send button 132 for transmitting the input aggregation comment are displayed are also displayed in the chat frame 122. Accordingly, each viewer performs aggregation of review comments using a chat system.

An input field 134 for inputting a final aggregation instruction comment and a complete aggregation button 136 for transmitting the input final aggregation instruction comment and ending the aggregation processing are displayed below the chat frame 122 in the window 120. In the case where a reviewer determines that an agreement is reached on the aggregation mode by a chat, the reviewer inputs the conclusion into the input field 134 and presses the complete aggregation button 136, so that aggregation may be completed. In this exemplary embodiment, aggregation is completed when one reviewer presses the complete aggregation button 136. However, for example, in creation of an electronic document, aggregation may be completed when all the reviewers press the complete aggregation button 136.

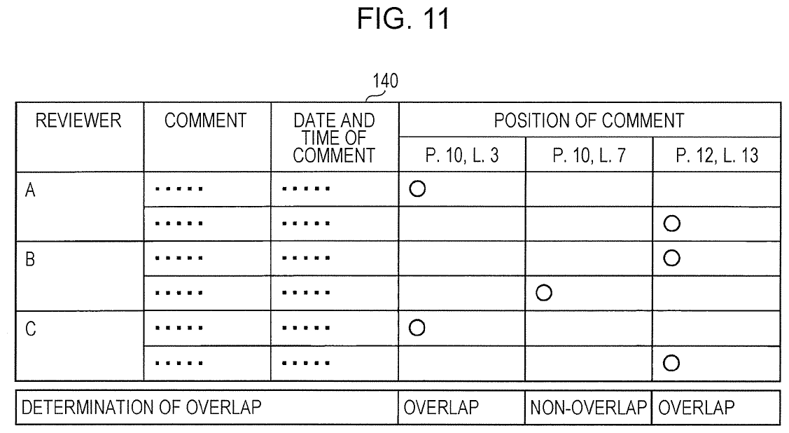

Finally, a process of the overlapping position determination unit 46 in the document review processing server 20 will be explained with reference to FIG. 11. FIG. 11 is a diagram illustrating an example of a comment table 140 obtained by performing analysis of review comments for the electronic document 102 illustrated in FIGS. 9 and 10. In the comment table 140, an input comment, a comment input date and time, and a position for which the comment is provided are described for each reviewer. Specifically, positions for which comments are provided are “Page 10, Line 3”, “Page 10, Line 7”, and “Page 12, Line 13”, and the positions for which the comments are provided are explicitly indicated by circle marks in the comment table 140.

The overlapping position determination unit 46 checks the comment table 140 to determine an overlapping position. Since comments by the reviewer A and the reviewer C are provided for “Page 10, Line 3” and comments by the reviewer A, the reviewer B, and the reviewer C are provided for “Page 12, Line 13”, the overlapping position determination unit 46 determines that these positions are overlapping positions for which the review comments are provided in an overlapping manner. Since only a review comment by the reviewer B is provided for “Page 10, Line 7”, the overlapping position determination unit 46 determines that review comments are not provided in an overlapping manner. As a result, as illustrated in FIGS. 9 and 10, an aggregation request is issued for each of the overlapping positions “Page 10, Line 3” and “Page 12, Line 13”, and the aggregation processing is thus performed.

In the explanation provided above, it is assumed that a dedicated application is installed in each of the review comment input apparatuses 70. However, for example, a dedicated application may not be installed in each of the review comment input apparatuses 70. The review comment input apparatuses 70 may access the document review processing server 20 via a web browser or the like and perform processing under the control of an application of the document review processing server 20. In this case, typically, aggregation comments in the review comment input apparatuses 70 are transmitted via the web browser. For communication of aggregation comments in the review comment input apparatuses 70, for example, e-mails may be used, instead of chats using an application or a web browser.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An electronic document review comment aggregation system comprising:
an aggregation request unit that requests, in a case where review comments are input for an overlapping position in an electronic document in an overlapping manner by a plurality of reviewers, aggregation of the review comments for the overlapping position from the plurality of reviewers;
an aggregation comment reception unit that receives aggregation comments input for the aggregation by the plurality of reviewers;
an aggregation comment display unit that displays the received aggregation comments for the plurality of reviewers; and
an aggregation ending unit that ends the aggregation in accordance with an aggregation ending condition.

2. The electronic document review comment aggregation system according to claim 1, further comprising:
an electronic document display unit that displays the electronic document while visually explicitly displaying the overlapping position,
wherein in a case where the overlapping position in the electronic document displayed by the electronic document display unit is operated, the overlapping position continues to be displayed and the aggregation comments by the aggregation comment display unit are displayed in association with the display of the overlapping position.

3. The electronic document review comment aggregation system according to claim 2,
wherein the electronic document display unit explicitly displays, among overlapping positions, an overlapping position for which aggregation is ended by the aggregation ending unit and an overlapping position for which aggregation is not ended by the aggregation ending unit in visually different modes.

4. The electronic document review comment aggregation system according to claim 1,
wherein in a case where there are a plurality of overlapping positions, the aggregation comment display unit displays the aggregation comments arranged for each of the overlapping positions.

5. The electronic document review comment aggregation system according to claim 4,
wherein the aggregation comment display unit displays the aggregation comments arranged in chronological order in that the aggregation comments are input.

6. The electronic document review comment aggregation system according to claim 4,
wherein the aggregation comment display unit displays the aggregation comments arranged for individual reviewers who have input the aggregation comments.

7. The electronic document review comment aggregation system according to claim 4,
wherein the aggregation comment display unit displays the input aggregation comments arranged in order of similarity.

8. The electronic document review comment aggregation system according to claim 1,
wherein the aggregation ending condition with which the aggregation ending unit complies is that an instruction for ending the aggregation is received from one or more reviewers.

9. The electronic document review comment aggregation system according to claim 8,
wherein in a case where an ending instruction image for receiving the instruction for ending the aggregation is displayed for the plurality of reviewers and any one of the plurality of reviewers operates the ending instruction image, the aggregation ending unit receives the instruction for ending the aggregation from the reviewer.

10. The electronic document review comment aggregation system according to claim 8,
wherein in a case where a delegation image for delegating the aggregation to one or more different reviewers is displayed for the plurality of reviewers and the delegation image is operated, the aggregation comment reception unit receives an aggregation comment indicating that the delegation has been conducted, and
wherein the aggregation ending unit receives the instruction for ending the aggregation from the delegated reviewer.

11. The electronic document review comment aggregation system according to claim 1, further comprising:
a determination unit that determines whether or not there is a need to aggregate the review comments input for the overlapping position,
wherein the aggregation request unit requests aggregation for comments for which the determination unit determines that there is a need to perform aggregation.

12. The electronic document review comment aggregation system according to claim 1, further comprising:
a suggesting unit that suggests an aggregation mode for the review comments provided in the overlapping manner.

13. The electronic document review comment aggregation system according to claim 1, further comprising:
a review comment request unit that requests review comments for the electronic document from two or more reviewers; and
a review comment reception unit that receives the review comments for a specified position in the electronic document from the requested reviewers.

14. A non-transitory computer readable medium storing a program causing a computer to execute a process for electronic document review comment aggregation, the process comprising:
requesting, in a case where review comments are input for an overlapping position in an electronic document in an overlapping manner by a plurality of reviewers, aggregation of the review comments for the overlapping position from the plurality of reviewers;
receiving aggregation comments input for the aggregation by the plurality of reviewers;
displaying the received aggregation comments for the plurality of reviewers; and
ending the aggregation in accordance with an aggregation ending condition.

15. An electronic document review comment aggregation and input apparatus comprising:
a review comment input unit that inputs a review comment for a selected position in an electronic document;
an aggregation request reception unit that receives, in a case where a review comment is input by a different reviewer who is different from a reviewer using the electronic document review comment aggregation and input apparatus for the position in the electronic document in an overlapping manner, request for aggregation of the review comments for the position;
an aggregation comment input unit that inputs an aggregation comment for the position; and
an aggregation comment display unit that displays aggregation comments input by the reviewer and the different reviewer.

16. A non-transitory computer readable medium storing a program causing a computer to execute a process for electronic document review comment aggregation and inputting, the process comprising:
inputting a review comment for a selected position in an electronic document;
receiving, in a case where a review comment is input by a different reviewer who is different from a reviewer using the computer for the position in the electronic document in an overlapping manner, request for aggregation of the review comments for the position;
inputting an aggregation comment for the position; and
displaying aggregation comments input by the reviewer and the different reviewer.
